(19) United States
(12) Patent Application Publication
(10) Pub. No.: US 2018/0079184 A1
(43) Pub. Date: Mar. 22, 2018

(54) Method of Adhering Polyurethane Foam Layer with at least One Surface Layer

(71) Applicant: Tun-Jen Ku, Taichung City 412 (TW)

(72) Inventor: Tun-Jen Ku, Taichung City 412 (TW)

(21) Appl. No.: 15/272,505

(22) Filed: Sep. 22, 2016

(51) Int. Cl. B32B 27/06; B32B 37/00; B32B 5/18; B32B 27/40

(52) U.S. Cl. CPC B32B 27/065; B32B 37/0053; B32B 2266/0278; B32B 27/40; B32B 5/18

(57) ABSTRACT

A method of adhering a polyurethane foam layer is used to successively stick the polyurethane foam layer with at least one surface layer by way of polyurethane system components in polymerization foaming action. The method contains steps of: A. delivering a release layer toward a cladding position by using a first rolling set; B. cladding the polyurethane system components on the release layer at the cladding position; C. delivering the polyurethane system components to a surface layer by using a second rolling set, after the polyurethane system components foam and polymerize on the release layer; D. conveying the surface layer and the polyurethane system components to a press roller so that the polyurethane system components foam to produce the polyurethane foam layer which adheres with the surface layer; and E. delivering the polyurethane foam layer away from the press roller.

### FIELD OF THE INVENTION

The present invention relates to a method of adhering a polyurethane foam layer which is applied to successively stick the polyurethane foam layer with at least one surface layer by way of polyurethane system components in polymerization foaming action so as to enhance adhesion and production capacity.

### BACKGROUND OF THE INVENTION

Polyurethane foam (PU foam) layer is made of polyurethane system components comprised of isocyanate component and polyol component, and water and catalyst are added into the polyurethane system components so that the water and the isocyanate component are mixed to produce carbon dioxide by which the polyurethane foam layer is foamed and is applicable for building materials, packaging material, and vibration absorption material, etc.

As shown in FIG. 1, a polyurethane foam layer 1 adheres with a surface layer 2, and the surface layer 2 is any one of a fabric layer, a leather layer, and an artificial leather layer.

A method of adhering the polyurethane foam layer 1 with the surface layer 2 contains steps of: cladding adhesive 3 on the polyurethane foam layer 1; and adhering the surface layer 2 on the polyurethane foam layer 1 by way of the adhesive 3. However, the adhesive 3 has defects as follows:

1. The adhesive 3 causes environment damage.

2. The polyurethane foam layer 1 cannot adhere with the surface layer 2 securely by using the adhesive 3.

3. After foaming the polyurethane foam layer 1, the adhesive 3 is cladded on the polyurethane foam layer 1 troublesomely.

4. After foaming the polyurethane foam layer 1, the adhesive 3 is cladded on the polyurethane foam layer 1 so that the polyurethane foam layer 1 adheres with the surface layer 2, but such an adhering method will limit production space.

The present invention has arisen to mitigate and/or obviate the afore-described disadvantages.

### SUMMARY OF THE INVENTION

The primary objective of the present invention is to provide a method of adhering a polyurethane foam layer which is applied to successively stick the polyurethane foam layer with at least one surface layer by way of polyurethane system components in polymerization foaming action so as to protect environment.

Secondary objective of the present invention is to provide a method of adhering a polyurethane foam layer which is applied to successively stick the polyurethane foam layer with at least one surface layer by way of polyurethane system components so as to enhance adhesion capacity.

Further objective of the present invention is to provide a method of adhering a polyurethane foam layer which is applied to successively stick the polyurethane foam layer with at least one surface layer by way of polyurethane system components so as to enhance production capacity.

Another objective of the present invention is to provide a method of adhering a polyurethane foam layer which is applied to successively stick the polyurethane foam layer with at least one surface layer by way of polyurethane system components so as to reduce production space.

### BRIEF DESCRIPTION OF THE DRAWINGS

FIG. 1 is a schematic view showing a conventional adhering method for a polyurethane foam layer and a surface layer.

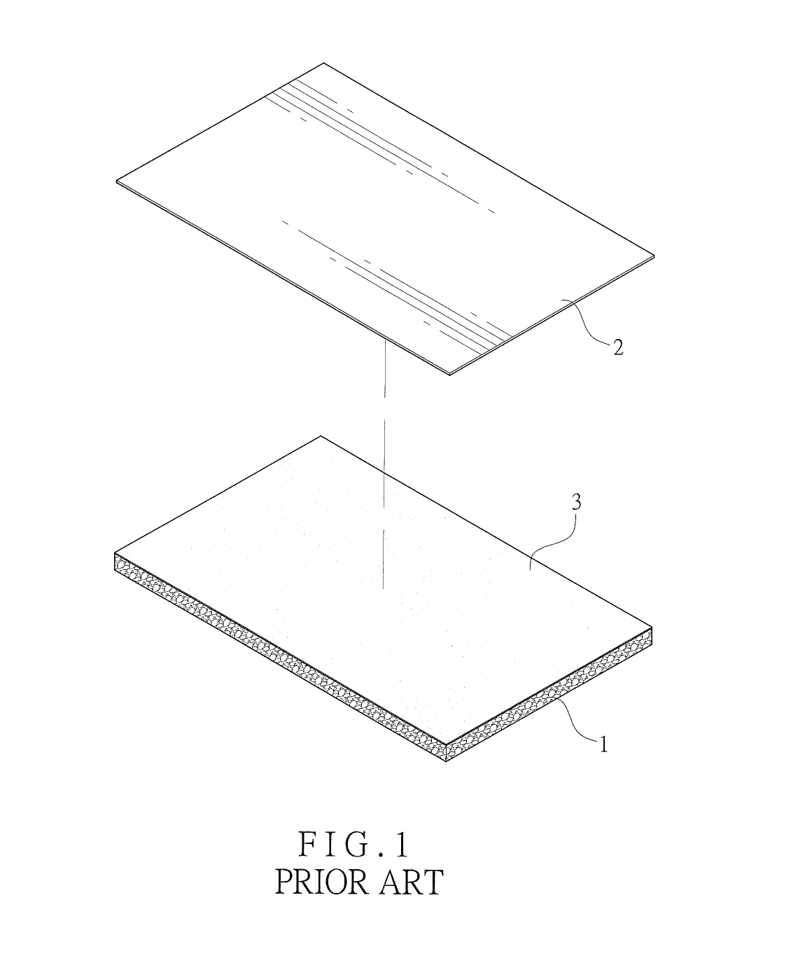

FIG. 2 is a schematic view of a method of adhering a polyurethane foam layer according to a first embodiment of the present invention.

FIG. 3 is a schematic view of a method of adhering a polyurethane foam layer according to a second embodiment of the present invention.

FIG. 4 is a schematic view of a method of adhering a polyurethane foam layer according to a third embodiment of the present invention.

### DETAILED DESCRIPTION OF THE PREFERRED EMBODIMENTS

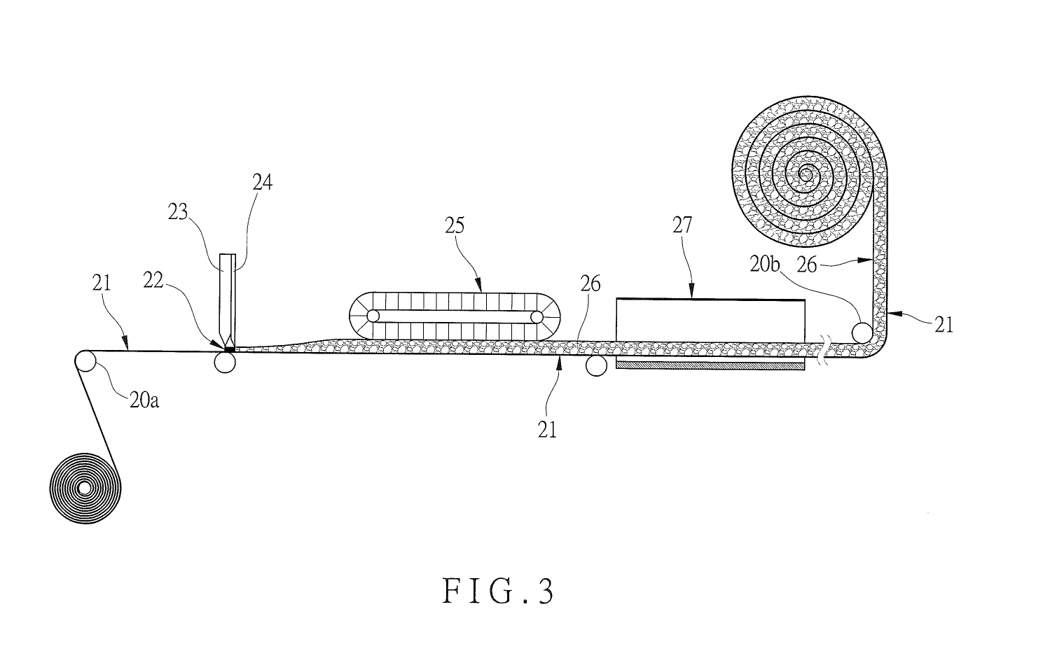

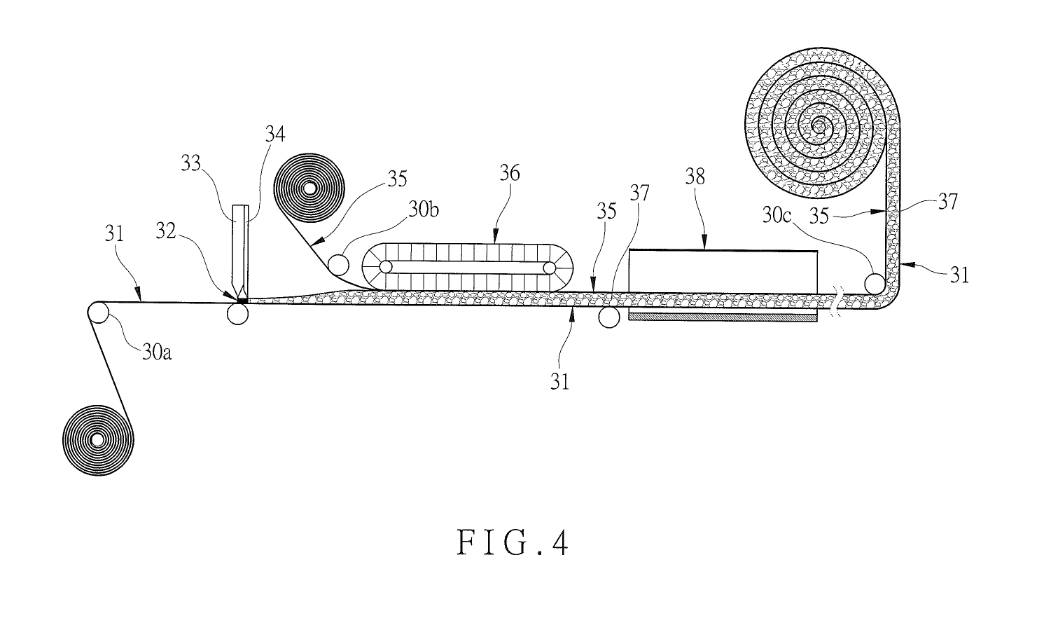

With reference to FIGS. 3 and 4, a method of adhering a polyurethane foam layer according to a first embodiment of the present invention is applied to successively stick the polyurethane foam layer with at least one surface layer by using polyurethane system components in polymerization foaming action, and the method contains a first method of adhering an upper surface of the polyurethane foam layer with a surface layer and a second method of adhering a lower surface of the polyurethane foam layer with the surface layer.

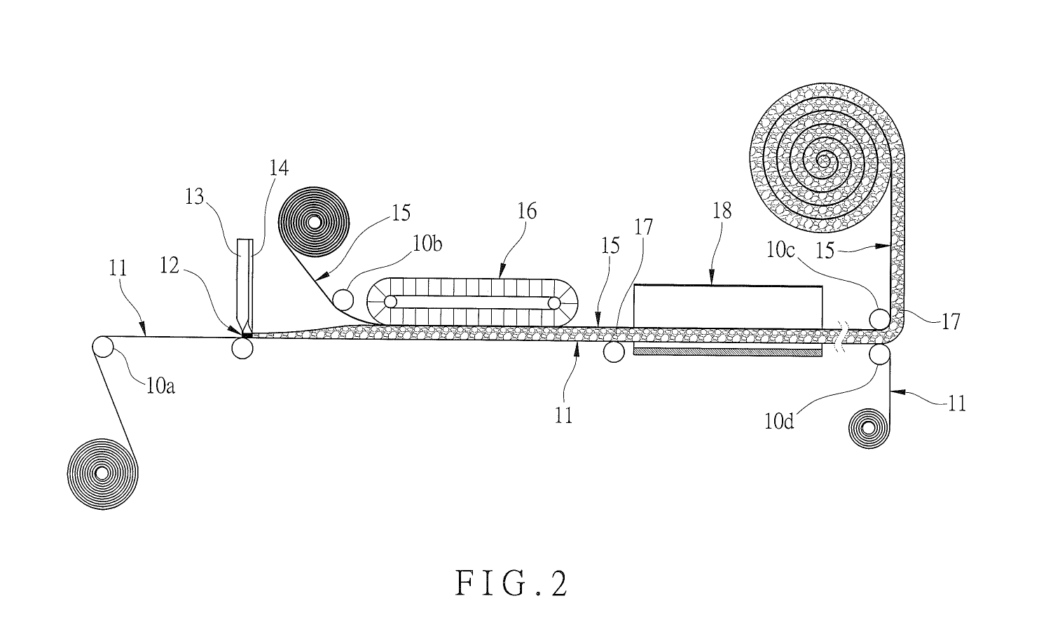

Referring to FIG. 2, the first method of adhering the upper surface of the polyurethane foam layer with the surface layer comprises a step of delivering a release layer 11 toward a cladding position by way of a first rolling set 10a. In this embodiment, the release layer 11 is removed from the polyurethane (PU) foam layer and is made of any one of silicone coating material, polyethylene (PE) material and metal material, such as metal foil. The first method of adhering the upper surface of the polyurethane foam layer further comprises a step of cladding the polyurethane system components 12 on the release layer 11 at the cladding position, wherein the polyurethane system components 12 are comprised of isocyanate component and polyol component, and water and catalyst are added into the polyurethane system components 12 so that the water and the isocyanate component are mixed to produce carbon dioxide by which the polyurethane foam layer is foamed, wherein when the polyurethane system components 12 are cladded on the release layer 11, they start foaming polymerization on the release layer 11. In this embodiment, the polyurethane system components 12 are cladded on the release layer 11 in a pouring manner or in a spraying manner, wherein a scraper 14 is mounted behind a mixing nozzle 13 so as to clad the polyurethane system components 12 evenly, and a cladding thickness of the polyurethane system components 12 is adjusted by changing a height position of the scrapper 14 and is determined based on a desired thickness of the polyurethane foam layer. The polyurethane system components 12 are delivered to a surface layer 15 by a second rolling set 10b, after foaming and polymerizing on the release layer 11, wherein the surface layer 15 adheres with the polyurethane foam layer and is any one of a fabric layer, a leather layer, and an artificial leather layer. Preferably, the polyurethane system components 12 enter into gaps of the surface layer 15 so as to adhere with the surface layer 15 securely. Thereafter, the surface layer 15 and the polyurethane system components 12 are conveyed to a press roller 16 so that the polyurethane system components 12 foam to produce the polyurethane foam layer 17 which adheres with the surface layer 15. Preferably, a height position of the press roller 16 is adjustable so as to control a foaming thickness of the polyurethane system components 12, and the foaming thickness of the polyurethane system components 12 is determined based on the desired thickness of the polyurethane foam layer 17. To avoid the press roller 16 adhering with the polyurethane system components 12, Teflon is coated on the press roller 16 or the press roller 16 is made of polyethylene (PE) material or a metal foil. Thereafter, the polyurethane foam layer 17 is delivered away from the press roller 16, thus adhering the polyurethane foam layer 17 with the surface layer 15 successively.

It is to be note that the polyurethane foam layer 17 does not polymerize completely, i.e., the polyurethane foam layer 17 polymerizes at 80% and does not adhere with the press roller 16. Thereafter, the polyurethane foam layer 17 finishes polymerization after 24 hours. To finish polymerization of the polyurethane foam layer 17 quickly, a baker 18 is arranged behind the press roller 16 so as to heat and dry the polyurethane foam layer 17. Alternatively, a heating apparatus is fixed on the press roller 16 so as to heat and dry the polyurethane foam layer 17. Thereafter, the polyurethane foam layer 17 is removed from the release layer 11 by using a third rolling set 10c and a fourth rolling set 10d, and the polyurethane foam layer 17 and the release layer 11 are rolled by the third rolling set 10c and the fourth rolling set 10d, respectively.

As shown in FIG. 3, the second method of adhering the lower surface of the polyurethane foam layer with the surface layer according to a second embodiment of the present invention comprises a step of: conveying a surface layer 21 toward a cladding position by way of a delivery roller set 20a, wherein the surface layer 21 adheres with the polyurethane foam layer and is any one of a fabric layer, a leather layer, and an artificial leather layer. The method of the second embodiment further comprises a step of cladding the polyurethane system components 22 on the surface layer 21 at the cladding position, wherein the polyurethane system components 22 are comprised of isocyanate component and polyol component, and water and catalyst are added into the polyurethane system components so that the water and the isocyanate component are mixed to produce carbon dioxide by which the polyurethane (PU) foam layer is foamed, wherein when the polyurethane system components 22 are cladded on the surface layer 21 evenly, they start foaming polymerization on the surface layer 21.

In this embodiment, the polyurethane system components 22 are cladded on the surface layer 21 in a pouring manner or in a spraying manner, wherein a scraper 24 is mounted behind a mixing nozzle 23 so as to clad the polyurethane system components 22 evenly, and a cladding thickness of the polyurethane system components 22 is adjusted by changing a height position of the scrapper 24 and is determined according to a desired thickness of the polyurethane foam layer. Preferably, the polyurethane system components 22 enter into gaps of the surface layer 21 so as to adhere with the surface layer 21 securely. Thereafter, the surface layer 21 and the polyurethane system components 22 are conveyed to a press roller 25 so that the polyurethane system components 22 foam to produce the polyurethane foam layer 26 which adheres with the surface layer 21. Preferably, a height position of the press roller 25 is adjustable so as to control a foaming thickness of the polyurethane system components 22, and the foaming thickness of the polyurethane system components 22 is determined based on the desired thickness of the polyurethane foam layer 26. To avoid the press roller 25 adhering with the polyurethane system components 22, Teflon is coated on the press roller 25 or the press roller 25 is made of polyethylene (PE) material or a metal foil. Thereafter, the polyurethane foam layer 26 is delivered away from the press roller 25, thus adhering the polyurethane foam layer 26 with the surface layer 21 successively.

It is to be note that the polyurethane foam layer 26 does not polymerize completely, i.e., the polyurethane foam layer 26 polymerizes at 80% and does not adhere with the press roller 25. Thereafter, the polyurethane foam layer 26 finishes polymerization after 24 hours. To finish polymerization of the polyurethane foam layer 26 quickly, a baker 27 is arranged behind the press roller 25 so as to heat and dry the polyurethane foam layer 26. Alternatively, a heating apparatus is fixed on the press roller 25 so as to heat and dry the polyurethane foam layer 26. Thereafter, the polyurethane foam layer 26 is rolled by a rolling set 20b.

As illustrated in FIG. 4, a method of successively adhering an upper surface and a lower surface of a polyurethane foam layer with at least one surface layer according to a third embodiment of the present invention comprises a step of delivering a first surface layer 31 toward a cladding position by using a first rolling set 30a, wherein the first surface layer 31 adheres with the polyurethane foam layer and is any one of a fabric layer, a leather layer, and an artificial leather layer. The method of the third embodiment further comprises a step of cladding the polyurethane system components 32 on the first surface layer 31 at the cladding position, wherein the polyurethane system components 32 are comprised of isocyanate component and polyol component, and water and catalyst are added into the polyurethane system components so that the water and the isocyanate component are mixed to produce carbon dioxide by which the polyurethane (PU) foam layer is foamed, wherein when the polyurethane system components 32 are cladded on the first surface layer 31 evenly, they start foaming polymerization on the first surface layer 31.

In this embodiment, the polyurethane system components 32 are cladded on the first surface layer 31 in a pouring manner or in a spraying manner, wherein a scraper 34 is mounted behind a mixing nozzle 33 so as to clad the polyurethane system components 32 evenly, and a cladding thickness of the polyurethane system components 32 is adjusted by changing a height position of the scrapper 34 and is determined according to a desired thickness of the polyurethane foam layer. Preferably, the polyurethane system components 32 are delivered to a second surface layer 35 by a second rolling set 30b, after foaming and polymerizing on the first surface layer 31, wherein the second surface layer 35 is identical to or is different from the first surface layer 31 according to using requirements. Preferably, the polyurethane system components 32 enter into gaps of the first surface layer 31 and the second surface layer 35 so as to adhere with the first surface layer 31 and the second surface layer 35 securely. Thereafter, the first surface layer 31, the polyurethane system components 32, and the second surface layer 35 are conveyed to a press roller 36 so that the polyurethane system components 32 foam to produce the polyurethane foam layer 37 which adheres with the first surface layer 31 and the second surface layer 35. Preferably, a height position of the press roller 36 is adjustable so as to control a foaming thickness of the polyurethane system components 32, and the foaming thickness of the polyurethane system components 32 is determined based on the desired thickness of the polyurethane foam layer 37. To avoid the press roller 36 adhering with the polyurethane system components 32, Teflon is coated on the press roller 36 or the press roller 36 is made of polyethylene (PE) material or a metal foil. Thereafter, the polyurethane foam layer 37 is delivered away from the press roller 36, thus adhering the polyurethane foam layer 37 with the first surface layer 31 and the second surface layer 35 successively.

It is to be note that the polyurethane foam layer 37 does not polymerize completely, i.e., the polyurethane foam layer 37 polymerizes at 80% and does not adhere with the press roller 36. Thereafter, the polyurethane foam layer 37 finishes polymerization after 24 hours. To finish polymerization of the polyurethane foam layer 37 quickly, a baker 38 is arranged behind the press roller 36 so as to heat and dry the polyurethane foam layer 37. Alternatively, a heating apparatus is fixed on the press roller 36 so as to heat and dry the polyurethane foam layer 37. Thereafter, the polyurethane foam layer 37 is rolled by a third rolling set 30c.

Accordingly, the polyurethane system components are applied to adhere the polyurethane foam layer with the at least one surface layer successively so as to protect environment and to enhance adhesion and production capacity. In addition, the polyurethane foam layer is capable of being produced in a limited space.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of adhering a polyurethane foam layer being applied to successively stick the polyurethane foam layer with at least one surface layer by way of polyurethane system components in polymerization foaming action, and the method comprising steps of:
A. delivering a release layer toward a cladding position by way of a first rolling set;
B. cladding the polyurethane system components on the release layer at the cladding position so that the polyurethane system components foam and polymerize on the release layer;
C. delivering the polyurethane system components to a surface layer by using a second rolling set, after the polyurethane system components foam and polymerize on the release layer so that the polyurethane system components adhere with the surface layer;
D. conveying the surface layer and the polyurethane system components to a press roller so that the polyurethane system components foam to produce the polyurethane foam layer which adheres with the surface layer; and
E. delivering the polyurethane foam layer away from the press roller.

2. The method as claimed in claim 1, wherein in the step of B, the polyurethane system components are comprised of isocyanate component and polyol component, and water and catalyst are added into the polyurethane system components.

3. The method as claimed in claim 1, wherein in the step of B, the polyurethane system components are cladded on the release layer in a pouring manner or in a spraying manner, wherein a scraper is mounted behind a mixing nozzle so as to clad the polyurethane system components evenly, and a cladding thickness of the polyurethane system components is adjusted by changing a height position of the scrapper and is determined based on a desired thickness of the polyurethane foam layer.

4. The method as claimed in claim 1, wherein in the step of D, a height position of the press roller is adjustable so as to control a foaming thickness of the polyurethane system components, and the foaming thickness of the polyurethane system components is determined based on the desired thickness of the polyurethane foam layer.

5. The method as claimed in claim 1 further comprising a step of providing a baker behind the press roller after the step of E or fixing a heating apparatus on the press roller in the step of D so as to heat and dry the polyurethane foam layer.

6. A method of adhering a polyurethane foam layer being applied to successively stick the polyurethane foam layer with at least one surface layer by way of polyurethane system components in polymerization foaming action, and the method comprising steps of:
A. delivering a first surface layer toward a cladding position by using a first rolling set;
B. cladding the polyurethane system components on the first surface layer at the cladding position so that the polyurethane system components foam and polymerize on and adheres with the first surface layer;
C. conveying the first surface layer and the polyurethane system components to a press roller so that the polyurethane system components foam to produce the polyurethane foam layer which adheres with the first surface layer; and
D. delivering the polyurethane foam layer away from the press roller.

7. The method as claimed in claim 6, wherein in the step of B, the polyurethane system components are comprised of isocyanate component and polyol component, and water and catalyst are added into the polyurethane system components.

8. The method as claimed in claim 6, wherein in the step of B, the polyurethane system components are cladded on the first surface layer in a pouring manner or in a spraying manner, wherein a scraper is mounted behind a mixing nozzle so as to clad the polyurethane system components evenly, and a cladding thickness of the polyurethane system components is adjusted by changing a height position of the scrapper and is determined based on a desired thickness of the polyurethane foam layer.

9. The method as claimed in claim 6 further comprising a step of delivering the polyurethane system components to a second surface layer by using a second rolling set after the step of B.

10. The method as claimed in claim 6 further comprising a step of providing a baker behind the press roller after the step of D or fixing a heating apparatus on the press roller in the step of C so as to heat and dry the polyurethane foam layer.
